(19) United States
(12) Patent Application Publication
(10) Pub. No.: US 2012/0211417 A1
(43) Pub. Date: Aug. 23, 2012

(54) Method and System for Controlling Carbon Source Feed to Denitrification Filters

(75) Inventors: Eugene Michael Vegso, Cranberry Township, PA (US); Ivan Xuetang Zhu, Cranberry Township, PA (US)

(73) Assignee: XYLEM WATER SOLUTIONS ZELIENOPLE, LLC, Zelienople, PA (US)

(21) Appl. No.: 13/396,366

(22) Filed: Feb. 14, 2012

Related U.S. Application Data
(60) Provisional application No. 61/442,472, filed on Feb. 14, 2011.

(51) Int. Cl. C02F 3/28

(52) U.S. Cl. 210/614; 210/209; 210/141

(57) ABSTRACT

A process for optimizing the carbon feed in a denitrification filter. The process utilizes in-line or off-line measurements of process variables in combination with feed forward and feedback control and increases or decreases the amount of carbon added based on a calculated reset rate determined on a periodic basis. The calculated reset rate may be a percentage of a theoretical value of the necessary carbon feed rate needed to remove the desired amount of nitrate-nitrogen. When the effluent nitrate-nitrogen is at a desired level and no rate change is necessary, the carbon feed rate is set to an average of one or more of the last filter runs. The process may also include a step wherein the carbon addition is increased immediately after backwashing to reestablish the biomass needed to produce the desired effluent in a step to regain process efficiency once that boost reestablishes the biomass.

### CROSS REFERENCE TO RELATED APPLICATIONS

This application claims priority to U.S. Provisional Patent Application No. 61/442,472, filed Feb. 14, 2011, the entire disclosure of which is hereby incorporated by reference.

### BACKGROUND OF THE INVENTION

1. Field of the Invention

The present invention is generally directed to a method for controlling the carbon source feed to downflow denitrification media filters or packed-bed filters and, more specifically, to a method of determining when, how often, and by what amount to adjust that carbon source feed rate so as to optimize the carbon source utilization and control the desired effluent quality.

2. Description of Related Art

Downflow denitrification media or packed-bed filters are used to remove nitrates from wastewater. The filter has a gravity downflow packed bed of media through which the wastewater is fed. Microorganisms, such as anoxic heterotrophic bacteria, are attached to the filter media. As the nitrate containing water passes through the media in the filter, the microorganisms break down the nitrates, using a carbon source, such as methanol, and release nitrogen gas. Provided that adequate denitrifying biology exists in the filter and the supplied amount of carbon is sufficient, it is possible to reduce effluent nitrate-nitrogen (NO₃—N) levels to a desired value and, in many cases, to less than 1 mg/L.

When using methanol as the carbon source, the relationship for denitrification is well known as noted in the US Environmental Protection Agency (EPA) Nitrogen Control Manual (EPA/625/R-93/010) dated September 1993.

The equation illustrates the stoichiometric factors for nitrate-nitrogen (NO₃—N), nitrite-nitrogen (NO₂—N) and dissolved oxygen (DO) used to calculate the amount of methanol (CH₃OH or MeOH) required to reduce influent nitrates and other carbon consuming constituents. For the purposes of this disclosure, the terms nitrate, nitrate-nitrogen or NO₃—N mean either NO₃—N or NO_{X}—N. The NO_{X}—N also includes that small amount of nitrite-nitrogen (NO₂—N) usually present in the filter influent and effluent.

From the EPA publication, the following equation having set multipliers is used to describe the overall methanol requirement:

M=2.47(NO₃—N)+1.53(NO₂—N)+0.87 DO

where:
M=methanol required, mg/L
NO₃—N=nitrate-nitrogen removed, mg/L
NO₂—N=nitrite-nitrogen removed, mg/L
DO=dissolved oxygen removed, mg/L
   For the purpose of this disclosure, the amount calculated according to this calculation shall be considered as 100% of theoretical.

### SUMMARY OF THE INVENTION

The present invention is directed to a process for optimizing the carbon feed in a denitrification media or packed-bed filter while maintaining the process effluent at desired nitrate-nitrogen levels. The process utilizes in-line or off-line measurements of process variables in combination with feed forward and feed back control and increases or decreases the amount of carbon added based on a calculated reset rate. The calculated reset rate may be determined on a periodic basis based on the time that it takes the water to travel through the filter, and may include an instrument response time and/or a biological response time. The calculated reset rate may be determined as a percentage of a theoretical value of the necessary carbon feed rate needed to remove the desired amount of nitrate-nitrogen. When the effluent nitrate-nitrogen concentration is at a desired level and no reset rate change is necessary, the carbon feed rate is set to an average of one or more of the last filter runs, or maintained the same. The carbon feed chemical may be methanol or any other suitable carbon source that may be utilized by the denitrifying biology.

The process may also include a step wherein the carbon addition is increased immediately after backwashing to reestablish the biomass needed to produce the desired effluent since backwashing a filter tends to purge some biology from the filter bed. The process may also include a step to regain process efficiency once that boost reestablishes the biomass.

The process may be utilized with a set of denitrification filters, an individual filter, or a system with a set or multiple sets of filters.

### BRIEF DESCRIPTION OF THE DRAWINGS

FIG. 1 is a schematic diagram of a denitrification filter system having one filter;

FIG. 2 is a schematic diagram of a denitrification filter system having two filters; and

FIG. 3 is a flow diagram of one embodiment of the inventive process.

### BRIEF DESCRIPTION OF THE INVENTION

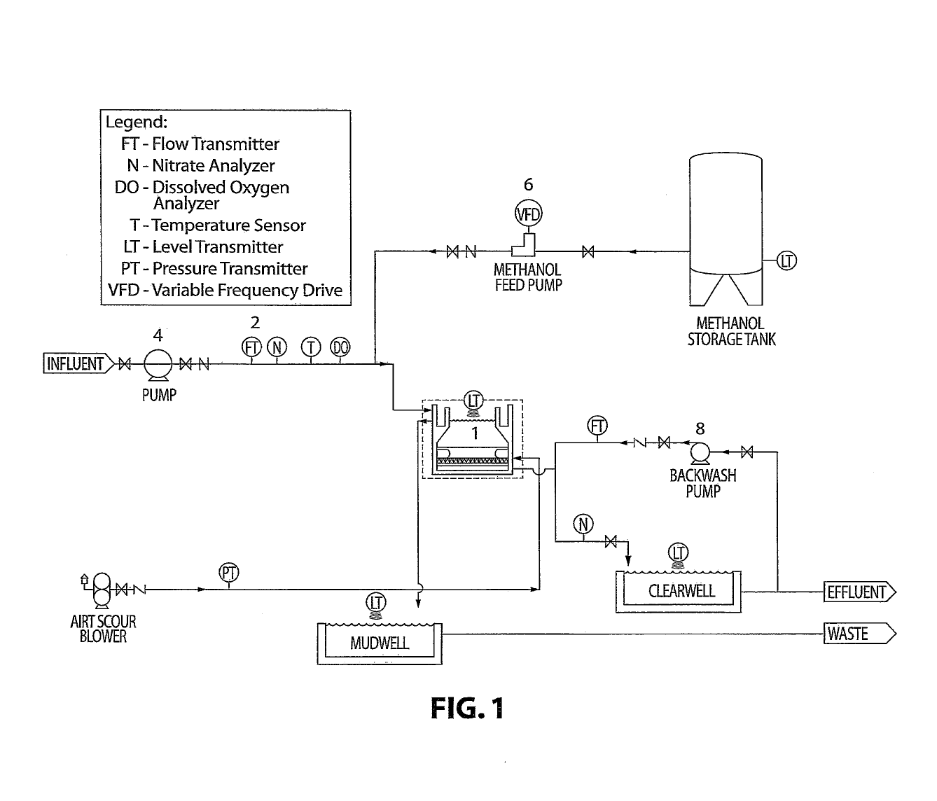

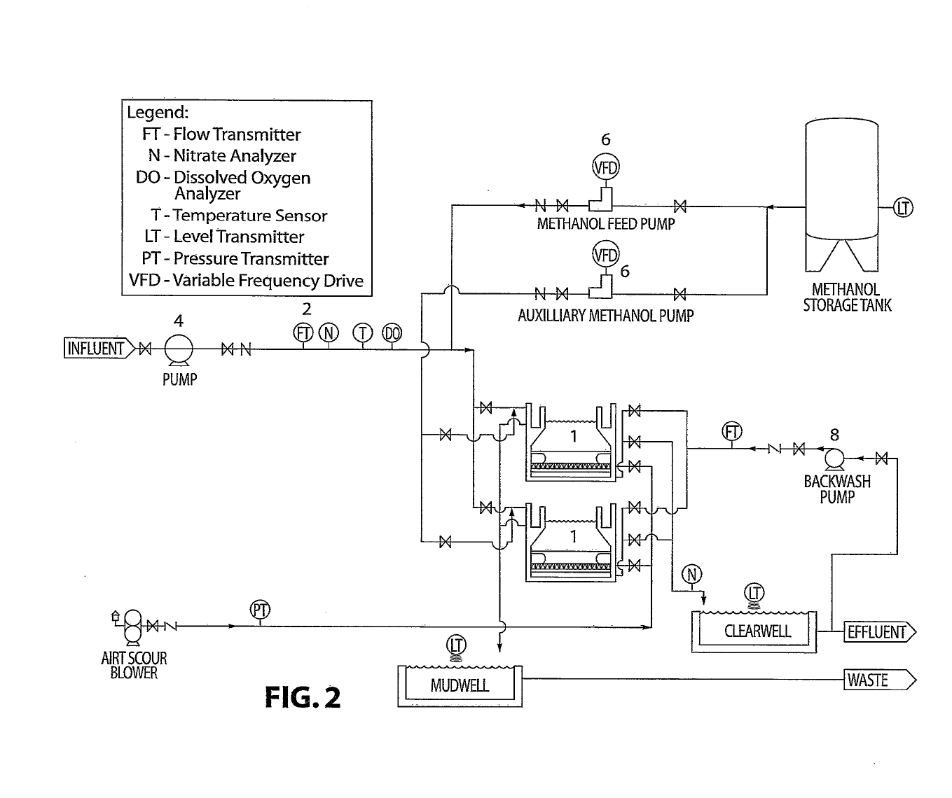

The inventive process is utilized to optimize the carbon feed in a denitrification media or packed-bed filter, such as the ones shown in FIGS. 1 and 2, while maintaining the process effluent at desired nitrate levels. FIG. 1 shows a filter system having one filter and one carbon feed system and FIG. 2 shows a filter system having two filters with two carbon feed systems. The process utilizes measurements taken by in-line measuring equipment or on samples that may be measured off-line. Variables utilized in the inventive process, which will be described below in detail, include influent nitrate-nitrogen concentration and dissolved oxygen concentration which may be measured at any point before the influent enters the filter 1, preferably before the carbon addition is made. In FIGS. 1 and 2, these measurements may be made at position 2. Effluent nitrate-nitrogen concentration and dissolved oxygen concentration are also utilized in the process and may be measured at any point after the effluent leaves the filter. In FIG. 1, these measurements are made at position 4. With regard to a filter system having two filters with two carbon feed systems, as shown in FIG. 2, a nitrate-nitrogen analyzer can be installed to one in common effluent line. Alternatively, a nitrate-nitrogen analyzer can be installed on each filter effluent line as opposed to one in common effluent line.

The flow rate of the fluid through the filter is also utilized in the process and may be measured at any point in the system, preferably in front of the filtration system, position 2 in FIGS. 1 and 2. All of the measurements may be directly communicated from the in-line measuring devices to a computer processor that is capable of communicating with, receiving inputs from, and sending output to and controlling the filter and any in-line measurement tools. The computer processor may be a PLC, a PC, or any computer processor capable of performing the necessary functions. The computer processor may also be capable of controlling the carbon additions to the filter and/or the flow of water through the system by communicating directly with the pumps, feed pump 4 and/or the methanol feed pumps 6 used for these purposes. The computer processor may also control the initiation of backwash cycles by communication with the backwash pump 8.

While the processes described herein are suitable for use with any type of carbon addition, it shall be described in detail herein with respect to methanol which is the most commonly utilized carbon source. Other carbon sources include acetic acid, ethanol, propanol, sugar, glucose, molasses, industrial wastes and other suitable electron donors that can be used by the denitrifying biology. Further, while the processes described herein utilize a computer processor, it should be understood that the processes may also be utilized without a computer processor by manually doing the necessary calculations and adjusting the carbon feed rate using measurement values from in-line measurement tools or samples taken from the described locations within the filter system and measured off-line.

Initial Feed Forward Calculation: The amount of methanol necessary to allow the biology to remove a desired amount of nitrate-nitrogen may be theoretically determined utilizing the previously discussed stoichiometric equation:

M=2.47(NO₃—N)+1.53(NO₂—N)+0.87 DO

where:
M=methanol required, mg/L
NO₃—N=nitrate-nitrogen removed, mg/L
NO₂—N=nitrite-nitrogen removed, mg/L
DO=dissolved oxygen removed, mg/L

For the purpose of this disclosure, the amount calculated according to this calculation shall be considered as 100% of theoretical. Due to actual operating conditions, water constituents and other factors, such as temperature, water quality, rainfall events, and operational changes, the value can be more or less than the noted theoretical amount provided by the equation. For example, during the course of normal daily operations there can be small to substantial variation in the influent nitrate-nitrogen levels and filter hydraulic loading rates. In order to produce the desired effluent, it is often necessary to employ both feed forward and feedback control.

The feed forward/feedback control uses the theoretical methanol equation shown above as the basis for establishing an initial amount of methanol to feed into the influent water. Should the amount of methanol be insufficient to reduce the effluent nitrate-nitrogen an adjustment may be made to boost the amount of methanol by a factor, percentage, or amount. Conversely if the calculated amount of methanol is excessive that amount could be lessened.

In order to preclude overfeeding, care must be taken to only feed enough methanol to achieve the desired effluent quality. To accomplish this, the desired effluent nitrate-nitrogen can be set slightly higher than zero, for example 0.7 mg/L of nitrate-nitrogen. This setpoint may be entered into the computer processor by an operator or stored in memory and may be changed depending on operating conditions. Using the theoretical equation, the computer processor makes the calculation using the influent and effluent nitrate-nitrogen concentration, nitrite-nitrogen concentration, and dissolved oxygen concentration measured by the in-line measuring device or input by the operator based on an off-line measurement:

Methanol=2.47(NO₃—N @ the influent −0.7 mg/L NO₃—N effluent setpoint)+1.53(NO₂—N)+0.87 DO

This equation is based on the assumption that there is no or low concentration of nitrite in the effluent and it is usually the case if the process is controlled properly.

Two feedback reset setpoints, a high and a low, can then be established with respect to the desired effluent nitrate-nitrogen concentration. These setpoints are based on how tightly it is desired that the system be controlled and may be automatically established by the computer processor or input by the operator. In the example above, a feedback reset high setpoint of 1.0 mg/L and a feedback reset low setpoint of 0.5 mg/L may be utilized. If the effluent nitrate-nitrogen concentration is within the bracket of the high and low range setpoints the methanol feed rate is not changed. Should the actual effluent nitrate-nitrogen exceed the high setpoint, the methanol feed rate is increased by a predetermined or a calculated amount. Conversely, if the nitrate-nitrogen concentration is lower than the low setpoint, the methanol feed rate is decreased by a predetermined or a calculated amount.

Since the amount of methanol required for denitrification usually varies with respect to the theoretical calculated amount noted in the theoretical equation, a multiplier or set value adder can be used to compensate for normal variances in the process. For example, a percentage multiplier can be used as shown below. This multiplier or adder may be stored in the computer processor or input by the operator and may be con-elated to specific measurements made by the in-line measuring devices or input by the operator. This example depicts a set multiplier of 115% for all constituents, but individual multipliers could be applied.

Methanol=[2.47(NO₃—N at the influent −0.7 mg/L effluent setpoint)×115%]+[1.53(NO₂—N)×115%]+[0.87 DO×115%]

Feedback Control: To compensate for efficiencies, variances and other factors that might change the efficiency, the multiplier may be adjusted up or down. The increase and decrease could be triggered by the effluent nitrate-nitrogen concentration rising above or falling below the reset setpoints. Once the setpoints are exceeded, the computer processor may change the percentage multiplier or set value by a factor or value. The amount of increase or decrease can be done at set amounts or by amounts that meet the need of the process based on the in-line or off-line measurements. The amount of the increase or decrease may be applied to the entire system, a portion of the system, a set of designated filters, or a single individual filter within a set of filters. For a filter system, such as the one shown in FIG. 2 having more than one filter, the amount of the increase or decrease may be the same for all filters or may be different for each filter or set of filters.

As mentioned above, the increase or decrease in the methanol feed factor can be a percentage or a fixed number. It also can be either a set value or derived by calculation. For example, both during a high or low limit reset, the allowable increase or decrease could be set to 2%. If such a 2% limit were applied to the example shown above, when the high setpoint is exceeded, the percentage feed would be increased to 117%, and when the low setpoint is not achieved, the feed factor would decrease to a value of 113%. To be even more responsive, the allowable methanol feed rate change may be set to 0.1% or more for either case of exceeding the high or low limits. These values could be set identically or independently.

The following is an example of feedback control for cases of under-dosing, i.e., the high setpoint is exceeded, and over-dosing of methanol, i.e., the low setpoint is not achieved:

Feedback Control (Over-Dosing)

| | |
|---|---|
| Current Feed Forward Multiplier | 115% |
| Nitrate-Nitrogen Effluent Target Value | 1 mg/L of NO₃—N |
| Measured Nitrate-Nitrogen Effluent Value | 0.4 mg/L of NO₃—N |
| Feedback Control Reset Setpoint (low limit) | 0.5 mg/L of NO₃—N |
| Allowable Incremental Change | 1.0% |
| Recalculated Feed Forward Multiplier | 114% |
| Feedback Control Reset Time | 30 minutes (calculated as |
| | described later) |
| Minimal Allowable Multiplier | 105% |

Feedback Control (Under-Dosing)

| | |
|---|---|
| Current Feed Forward Multiplier | 115% |
| Nitrate-Nitrogen Effluent Target Value | 1 mg/L of NO₃—N |
| Current Effluent Value | 1.5 mg/L of NO₃—N |
| Feedback Control Reset Setpoint (high limit) | 1.1 mg/L of NO₃—N |
| Allowable Incremental Change | 1.0% |
| Recalculated Feed Forward Multiplier | 116% |
| Feedback Control Reset Time | 30 minutes (calculated as |
| | described later) |
| Maximal Allowable Multiplier | 125% |

The control reset high and low limits shown above are used as “clamps” to limit the process. They may be stored in the computer processor's memory or may be input by the operator and may be set to automatically change depending on the measured variables.

Reset Time Calculation and Control: The resetting of the increase or decrease may be done at preset intervals or at intervals that meet the needs of the process.

Reset intervals may be calculated by the computer processor based on the total time it takes for the water to travel from a predetermined point at the influent stream to the point in the effluent stream where the water sample is collected for measurement or measured in-line (residence time). The predetermined influent point may be the point where the methanol is injected. The computer processor must be supplied with or have the necessary information to calculate the area of the filter cell(s), the flow rate to the cell(s), the water volume in the influent piping, the water volume over the media, the water volume in the media, the water volume in the effluent piping and channel, the time of the sample measurement, and any instrument response time for online instruments.

In addition to the residence time, an additional factor may be used to account for a biological response time. This value can be derived empirically or by calculation of known biological kinetics. Factored with the residence time, the total time calculated can be used as the “Reset Response Time”.

The following is an example of how the computer processor would calculate the Reset Response Time for a typical filter with 500 ft² of surface area, 6 ft of media with a void volume of 40%, and:

| | |
|---|---|
| Influent piping from the point of methanol addition | 1,000 gallons |
| Influent channel | 1,000 gallons |
| Water over the media | 15,000 gallons |
| Water in the media | 9,000 gallons |
| Underdrain & effluent channel | 2,000 gallons |
| Effluent piping | 1,000 gallons |
| Total | 29,000 gallons |

Reset Response Time=total water volume in the system (gal.)/flow rate (gal./min.)

With a flow rate of 1,000 gpm the total residence time calculates to 29 minutes.

29,000 gallons/1,000 gallons per minute=29 minutes

Additional time may be added for instrument response time, for example, 2 minutes resulting in at least 31 minutes of response time from the time a methanol feed adjustment would make a difference to the time one could expect to see results.

In this example, the influent/effluent piping, influent channel, and water in the media are fixed volumes. The water over the media can be a variable volume with volumes varying substantially during the course of operation. The water over the media can be calculated from the filter level sensors and filter cross-section area (input by the operator) and the number of filters online.

The flow rate can be fixed but is usually variable and susceptible to diurnal swings. Considering the variability, a calculated reset rate utilizing actual, measured process values is an improvement over a set reset rate since it allows a proper response over varying conditions. To account for the flow variability, the computer processor can use the following equation to constantly update the total residence time. See the following calculation:

$$T = \frac{A \times \frac{1}{n} \times {\sum }_{1}^{n} ( {L}_{n} - h ) + V 1 + V 2 + V 3}{F}$$

where
V1=influent and effluent piping volume between methanol dosing point and effluent nitrate-nitrogen sensing point (m³)
V2=influent channel volume (m³)
V3=water in the media (m³)=Area (m²)×h(m)×v×n, where h is height of the media and v is void percentage of media
A=total area of the filters in service (m²)
n=total number of filters in service
Lₙ=water level in filter n (m)
F=flow rate (m³/min)

As previously mentioned, V1 and V3 are constant for a given filter system. The computer processor may calculate V3 using the area of the media, which is a constant, media height, media void percentage, and number of filters online. Flow rate may be determined by the in-line sensing device and communicated to the computer processor.

In addition to the variability of the residence time, a given biomass must be afforded time to respond to process changes. This “Biological Response Time” or reaction time may be based on empirical observations or theoretical calculations that take into account the temperature, the difference between the desired effluent nitrate-nitrogen concentration setpoint and the measured effluent nitrate-nitrogen concentration, the overall efficacy of unit operations, the hydraulic loading, the maturity of the biology, the amount of nitrate loading, the amount of desired nitrate removal, the overall kinetics of the carbon source, unique process aspects of the pretreatment system, and other potential unknown factors. The following is an example of a calculation used by the computer processor to calculate the residence time including a set additional time, five minutes, to be added to the calculation to account for the biological response time and other variability.

$$T = \frac{A \times \frac{1}{n} \times {\sum }_{1}^{n} ( {L}_{n} - h ) + V 1 + V 2 + V 3}{F} + 5 minutes$$

Reset Rate Calculation and Control: As an alternative to a set amount of methanol feed rate change as detailed in the Feedback Control section above, actual process conditions can be used by the computer processor to calculate the methanol feed rate change. The unit or system operations may be factored in to provide a percentage of efficiency for unit operations. Using that percentage the computer processer may calculate how much to adjust the methanol feed rate.

The necessary variables that must be communicated to the computer processor and where they will be communicated from are shown below along with values for each variable that will be used to provide an example of the calculations that will be made by the computer processor.

| | | Communicated to the |
|---|---|---|
| Variable | Value | Computer Processor by: |
| Percentage of theoretical | 110% | Current setpoint in computer |
| feed at the time of | | processor memory that is |
| measurement | | being used to control |
| | | methanol addition |
| Influent Nitrate-Nitrogen | 15 mg/L | In-line sensor or input by |
| concentration | | operator from off-line test |
| Influent Nitrite-Nitrogen | 0.2 mg/L | Constant stored in the |
| concentration | | computer processor memory |
| | | or input by the operator, |
| | | or a value from process |
| | | measurement |
| Influent Dissolved Oxygen | 6 mg/L | In-line sensor or input by |
| | | operator from off-line test |
| Effluent Nitrate-Nitrogen | 1 mg/L | Stored in the computer |
| concentration setpoint | | processor memory or input |
| | | by the operator |
| Effluent Nitrate-Nitrogen | 4 mg/L | In-line sensor or input by |
| concentration | | operator from off-line test |
| Effluent Nitrite-Nitrogen | 0 mg/L | Constant stored in the |
| concentration | | computer processor memory |
| | | or input by the operator, |
| | | or a value from process |
| | | measurement |
| Effluent Dissolved Oxygen | 0 mg/L | In-line sensor or input by |
| | | operator from off-line test |

Using the theoretical formula, the computer processor may calculate the methanol addition (M_{SP}) necessary to achieve the effluent nitrate-nitrogen concentration setpoint, in this example, 14 mg/L (15 mg/L in the influent−setpoint of 1 mg/L in the effluent) and the amount of the actual addition (M_{A}) being made at the current feed rate, in this example 110% of the theoretical value.

M_{SP} or M_{A}=[2.47×(15 mg/L NO₃—N at the influent−1.0 mg/L effluent setpoint)]+[1.53×0.2 NO₂—N]+[0.87×6 mg/L DO]×(100% or 110%)
Calculated Methanol Required to Achieve the Setpoint (M_{SP})=40.11 mg/L
Methanol Actually Fed at the 110% of Theory Rate (M_{A})=44.12 mg/L

Then, the computer processor may use the theoretical formula to determine the amount of methanol (M_{C}) that the formula indicates would be required to remove the amount of nitrate-nitrogen that is actually being removed based on the influent nitrate-nitrogen content and the effluent nitrate-nitrogen content measured by the in-line sensors and communicated to the computer processor or input by the operator based on off-line measurements. In this example, 11 mg/L of nitrate-nitrogen are being removed (15 mg/L in the influent−4 mg/L in the effluent). Based on only removing 11 mg/L with all other things being equal at 100% of the theoretical methanol addition calculation the methanol requirement would be only 32.70 mg/L:

M_{C}=[2.47×(15 mg/L NO₃—N at the influent−4.0 mg/L in the effluent)]+[1.53×0.2 NO₂—N]+[0.87×6 mg/L DO]
Calculated Methanol to Remove the Actual Amount of Methanol Being Removed (M_{C})=32.70 mg/L

The computer processor can then calculate the efficiency of the actual methanol utilization, the approximate process efficiency, by comparing the calculated amount of methanol that should be necessary to remove the amount of nitrate-nitrogen that has actually been removed and the amount of methanol that has actually been used to remove the nitrate-nitrogen that has been removed. In this example, 32.70 mg/L and 44.12 mg/L, respectively.

Actual percentage of methanol utilization (approximate process efficiency)=M_{C}/M_{A} 32.70/44.12=74% process efficiency or about 134.9% of theoretical utilization

The computer processor may then calculate, using only the nitrate-nitrogen portion of the theoretical formula, how much additional methanol (M_{ADD}) to feed in order to remove the additional nitrate-nitrogen to achieve the effluent nitrate-nitrogen setpoint. In this example, there is 3 mg/L (4mg/L measured−1 mg/L setpoint) of excess nitrate-nitrogen in the effluent:

M_{ADD}=3 mg/L nitrate-nitrogen×2.47×134.9%=10.0 mg/L

The computer processor will add this additional amount of methanol (M_{ADD}) to the amount that is currently being feed (M_{A}) into the system to determine the total amount of methanol (M_{T}) necessary to achieve the effluent nitrate-nitrogen setpoint. In this example, adding the 10.0 mg/L to the 110% feed rate:

M_{T}=M_{A}+M_{ADD}=44.12+10.0=54.12 mg/L

The computer processor will compare this total methanol value (M_{T}) to the amount of methanol that the theoretical formula indicates would be necessary to achieve the effluent nitrate-nitrogen setpoint (M_{SP}) to determine the percentage of the theoretical value that is actually necessary to achieve the setpoint under current operating conditions and efficiency.

Required feed rate=M_{T}/M_{SP}=54.12/40.12=134.9%

The computer processor will then communicate with the methanol feed pump to increase the methanol content to this feed rate resulting, in this example, in a 24.9% boost (134.9% required feed−110% current feed).

The computer processor will repeat these calculations and readjust the methanol feed rate at time intervals based on the set Reset Response Time or the Reset Response Time calculated by the computer processor as described above until the effluent nitrate-nitrogen concentration falls below the High Feedback Control Reset Setpoint as described in the Feedback Control section above. After falling below that point the percentage of theoretical will automatically resume the last average as described below and the feedback control will be disengaged until the effluent nitrate-nitrogen concentration once again falls outside of either the high or low feedback control reset setpoints.

While the previous discussion has focused on a situation where the effluent nitrate-nitrogen concentration exceeded the high setpoint, the computer processor utilizes the same formulas and follows the same logic for lowering the feed rate when the effluent nitrate-nitrogen concentration is below the low setpoint.

When the effluent nitrate-nitrogen concentration is between the high and low feedback control reset setpoints and no reset is needed, the methanol feed rate is controlled based on calculations by the computer processor of the average percentage of theoretical methanol consumption since the last backwash as described next or maintained the same.

Percentage of Theory and Runtime Prediction Based on Removed Nitrate Loading: During each filter run, a run being from one backwash cycle to the next, the computer processer will keep a running summation that compares the total nitrate-nitrogen removed to the theoretical amount of nitrate-nitrogen that would have been removed by the methanol fed into the system if the process was working at 100% of theoretical. This value includes the amount of methanol necessary for the dissolved oxygen portion.

$P = \frac{{\int }_{To}^{Tf} MeOH \times \frac{F}{n} \times d t}{{\int }_{To}^{Tf} \{ ( {N}_{i} - {N}_{e} ) \times 2.47 + {NIT}_{i} \times 1.53 + ( {DO}_{i} - {DO}_{e} ) \times 0.87 \} \times \frac{F}{n} \times d t}$

| | | Communicated to the |
|---|---|---|
| Symbol | Represents | Computer Processor by: |
| P | percentage theory of methanol | |
| | consumption | |
| Nᵢ | instantaneous influent nitrate- | in-line measurement sensor |
| | nitrogen concentration | |
| Nₑ | instantaneous effluent nitrate- | in-line measurement sensor |
| | nitrogen concentration | |
| NITᵢ | instantaneous influent nitrate- | in-line measurement sensor |
| | nitrogen concentration | |
| DOᵢ | instantaneous influent dissolved | in-line measurement sensor |
| | oxygen concentration | |
| DOₑ | instantaneous effluent dissolved | in-line measurement sensor |
| | oxygen concentration | |
| MeOH | instantaneous methanol dosage | the methanol addition pump |
| F | Flow | in-line measurement sensor |
| n | number of filters in service | |
| t | Time | the computer processor |
| | | internal clock |
| T₀ | time right after a backwash | the computer processor |
| T_{f} | time before the next backwash | memory |

T_{f} may be a set time period input by the operator or stored in the computer processor memory or may be calculated by comparing the current accumulated amount of removed nitrate-nitrogen removed and the current amount of nitrate-nitrogen loading rate to the average accumulated amount of removed nitrate-nitrogen from the last n number of runs. The total number of previous runs used to determine the average total nitrate-nitrogen removed can be operator selectable.

$$t = \frac{{\sum }_{1}^{n} ( Ni \times {t}_{i} )}{n \times N}$$

where:
t=predicted filter run time
tᵢ=the run time of the i^{th} filter run
Ni=the accumulated amount of the removed nitrate-nitrogen in the previous i^{th} run
n=number of previous runs
N=the accumulated amount of the removed nitrate-nitrogen in the current run

The accumulated amount of removed nitrate-nitrogen for a previous run, Ni, may be calculated by the computer processor during the run using the following formula and stored in the computer processor memory:

$$N = {\int }_{{T}_{0}}^{{T}_{f}} ( {N}_{i} - {N}_{e} ) \times \frac{F}{n} d t$$

where:
N=accumulated amount of the removed nitrate-nitrogen
Nᵢ=instantaneous effluent nitrate-nitrogen concentration
Nₑ=instantaneous effluent nitrate-nitrogen concentration
F=flow
n=number of filters in service
t=time
T₀=time right after a backwash
T_{f}=time before the next backwash is initiated

The accumulated amount of removed nitrate-nitrogen for a current run, N, is determined using the same formula where T_{f} is the current time.

As a diagnostic tool for operators, the total amount of nitrate-nitrogen removed may be displayed as the “Previous Run Cycle Loading” and compared to the theoretical amount of loading as detailed in the US EPA Nitrogen Control Manual.

The average efficiency, P, of the previous single or multiple filter runs may be used as an indicator as to how the current and last completed filter run compares to the cumulative average. The total amount of comparative filter runs that are averaged can be operator selectable and these values may be displayed by the computer processor. For example:

| DISPLAY TITLE | Percentage | |
|---|---|---|
| PREVIOUS 50 FILTER RUNS | 107.5% | (The 50 can be operator |
| | | selectable from 1 to |
| | | XXXX) |
| PREVIOUS FILTER RUN | 111.6% | (This value is part of the |
| | | Previous 50 Runs) |
| CURRENT FILTER RUN | 109.1% | (Dynamic Value) |

The computer processor will constantly update the average efficiency for the current run until the unit is taken off-line for backwashing. When the filter is taken off-line for any other reason except backwashing, the average efficiency will remain constant until the unit resumes filtering. At that time, the computer processor will resume updating the average efficiency.

When the effluent nitrate-nitrogen concentration is between the high and low feedback control reset setpoints and no reset is needed, the methanol feed rate is set to an average efficiency value for the last run or the last several runs, or maintained the same. The number of runs used to determine the average may be operator selectable.

To preclude a filter, set of filters, or the system from having a “Runaway Event” where the percentage or amount of change continues to increase or decrease beyond reasonable limits (zero methanol output or to a point of maximum methanol output), a set of high and low limits can be configured to provide a safeguard so that the process cannot be compromised by a measurement failure or other anomaly. The limits when using a percentage multiplier could be:
Maximal allowable multiplier for methanol consumption=101% or higher
Minimal allowable multiplier for methanol consumption=99% or lower

As an indicator for the removed nitrate loading during normal operation, Cumulative Average Run Cycle Loading (CARCL) will also be calculated and displayed. This is calculated using the following:

$$CARCL = \frac{1}{A} \times {\int }_{{T}_{0}}^{{T}_{f}} ( {N}_{i} - {N}_{e} ) \times F d t$$

Nᵢ=instantaneous effluent nitrate-nitrogen concentration
Nₑ=instantaneous effluent nitrate-nitrogen concentration
F=flow
t=time
T₀=time right after a backwash
T_{f}=time before the next backwash is initiated
A=total area of the filters in service

Cumulative Average Run Cycle Loading will be based on the average of the last 50 of filter runs or a user selectable number. And a typical display can be as follows:

| DISPLAY TITLE | Loading Rate #/ft² |
|---|---|
| Average Cycle Loading | 0.43 #/ft² |
| Previous Cycle Loading | 0.39 #/ft² |

After Backwash Rate Boost Control: There are other periods when more methanol is required than what would be indicated by the theoretical calculation plus the additional amount described above. One of these times is immediately after backwashing. Operational data suggests that backwashing both disturbs and purges some of the denitrifying biomass. Operational data also suggests that adding an increased amount of methanol after backwashing provides the additional carbon required to hasten the reestablishment and regrowth of any purged biomass.

The calculations as described above can also be used to calculate the necessary methanol feed rate immediately after a backwash, but operational experience suggests that reestablishing filter operations at the percentage of theoretical methanol feed rate applied immediately before the backwashing is usually not sufficient to reestablish any lost biomass. To address this condition, a predetermined amount of “After Backwash Boost” to the filter or set of filters finishing backwash serves to hasten the reestablishment of the biomass needed to meet process requirements.

To accomplish this, the computer processor may use the preceding average theoretical efficiency from the last filter run as a base and supplement that value with a predetermined or calculated amount of additional methanol. This supplemented amount can be an additional percentage or a manually set numerical value.

Operational experience indicates that the boosted amount is necessary for that portion of time that it takes for the biomass to re-grow before releasing the filter to the control process as previously described. The time for biomass regrowth can be a set value input by the operator or may be the result of calculations made by the computer processor. The boosted amount of methanol depends on the strength of the backwash regime employed. One example is described as follows. It was observed that an extra 20% methanol was needed immediately after backwash at 12° C. with 3 minutes air, 8 minutes concurrent air at 5 SCFM/ft², water at 7 gpm/ft², and water only for 9 minutes. Based on this or other empirically derived values, the computer processor can determine the amount by which the methanol feed should be boosted based on the temperature of the system as determined by in-line sensors using the following formula:

Boosted Percentage=a^{12-T}×20%

where:
a=Arrhenius coefficient, and it is between 1.03 and 1.09 for fixed film denitrification filters
T=Temperature (° C.)

The time for which the methanol boost is needed may also be calculated by the computer processor. The time required for biomass re-growth is approximately equal to microbial doubling time and can be calculated as follows:

$$\frac{d X}{d t} = μ X$$

$$t = \frac{Ln ( 2 ) \times 24}{μ}$$

where:
X=biomass-biomass density (g/m³)
t=biomass re-growth time (hours)
μ=biomass specific growth rate (/day), temperature dependent
Ln=Natural log

To facilitate this function an additional methanol delivery pump can be used along with a set of solenoids, automatic valves, manual valves or other means so that the boost in methanol would only be directed to that filter that just finished the backwash. The normal complement of other operational filters, filter cells or remainder of the plant would continue receiving the amount of methanol as previously described.

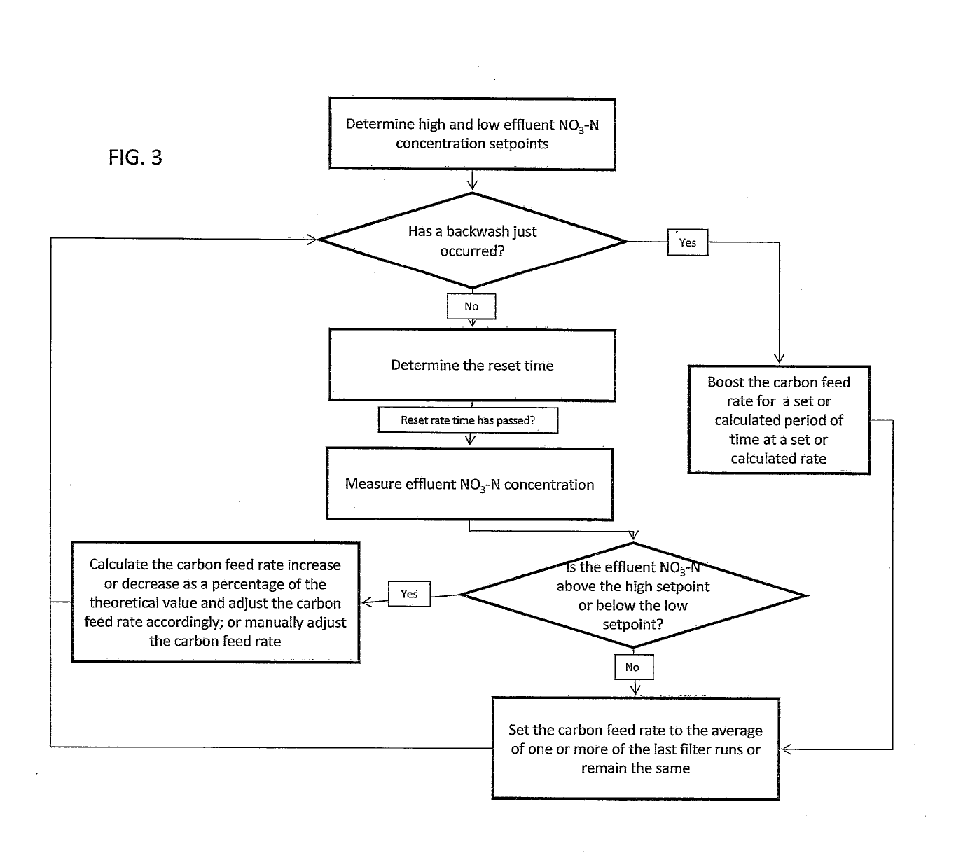

FIG. 3 shows a flow diagram of one embodiment of the inventive process that utilizes both the calculated carbon feed rate and the after-backwash boost described herein.

1. An automatic method for dosing and controlling an external carbon source in a denitrification process for a wastewater filter system having influent and effluent aqueous flows and a filtration bed harboring microbes, the method comprising:
a) providing a chemical comprising carbon to the wastewater at a predetermined feed rate;
b) calculating a starting rate of carbon feed based on influent constituent values, influent flow rate and desired effluent values;
c) setting high and low setpoints for effluent nitrate-nitrogen concentration;
d) measuring actual effluent nitrate-nitrogen concentration;
e) comparing the actual effluent nitrate-nitrogen concentration to the desired setpoint;
f) changing the carbon feed rate when the effluent nitrate-nitrogen concentration falls below the low setpoint or above the high setpoint, wherein the carbon feed rate is changed by a user input amount or by a calculated amount based on process efficiencies; and
g) providing adequate time, as determined by fluid residence time, instrument response time, biological response time, or a combination thereof, for the carbon rate adjustment to take affect and be measured.

2. The method according to claim 1, wherein the predetermined carbon feed rate is a calculated theoretical amount necessary to remove the desired amount of nitrate-nitrogen, wherein the calculated theoretical amount is determined based on influent flow rate, influent nitrate and nitrite concentration, influent dissolved oxygen concentration, and desired effluent nitrate concentration.

3. The method according to claim 1, wherein the calculated change in carbon feed rate is determined as a percentage of a theoretical amount of the necessary carbon feed rate needed to remove the desired amount of nitrate-nitrogen.

4. The method according to claim 1, further comprising comparing the actual effluent nitrate-nitrogen concentration to the setpoints on a periodic basis.

5. The method according to claim 4, wherein the periodic basis is determined by calculating the time that it takes the wastewater to flow through the filter system from a point in the influent stream where an influent nitrate-nitrogen concentration is measured to a point in the effluent stream where the effluent nitrate-nitrogen concentration is measured.

6. The method according to claim 5, wherein the measurement point in the influent stream is the point where the carbon feed chemical is injected.

7. The method according to claim 4, wherein the periodic basis is increased by an amount of time based on process water residence time, instrument response time, biological response time, or a combination thereof.

8. The method according to claim 1, wherein when the effluent nitrate-nitrogen concentration is between the high and the low setpoints, the carbon feed rate is set to an average feed rate of one or more previous filter runs, or maintained the same, a filter run being defined as the operational time between backwashes.

9. The method according to claim 1, wherein the filter system comprises more than one filtration bed and the process is applied individually to each bed.

10. The method according to claim 1, wherein the filter system comprises more than one filtration bed and the process is applied to the filtration system as a whole.

11. The method according to claim 1, wherein a computer processor having a memory and capable of communicating with, receiving inputs from, sending output to, and controlling the filter system and any in-line measurement tools is utilized.

12. The method according to claim 1, wherein the chemical comprising carbon is methanol, acetic acid, ethanol, propanol, sugar, glucose, molasses, industrial wastes, and other electron donors than can be utilized by denitrifying biology.

13. The method according to claim 1, wherein the calculated change in the carbon feed rate is determined by comparing actual efficiency of the carbon feed rate to a theoretical value of the necessary carbon feed rate needed to remove the desired amount of nitrate-nitrogen.

14. An automatic method for dosing and controlling an external carbon source in a denitrification process for a wastewater filter system having influent and effluent aqueous flows and a filtration bed harboring microbes, the method comprising:
a) providing a chemical comprising carbon to the wastewater at a predetermined feed rate;
b) calculating a starting rate of carbon feed based on influent constituent values, influent flow rate and desired effluent values;
c) setting high and low setpoints for effluent nitrate-nitrogen concentration;
d) measuring actual effluent nitrate-nitrogen concentration;
e) comparing the actual effluent nitrate-nitrogen concentration to the desired setpoint;
changing the carbon feed rate when the effluent nitrate-nitrogen concentration falls below the low setpoint or above the high setpoint, wherein the carbon feed rate is changed by a user input value or a calculated amount based on the process efficiencies;
g) providing for adequate time, as determined by fluid residence time, instrument response time, biological response time, or a combination thereof, for the carbon rate adjustment to take affect and be measured;
h) boosting the chemical feed rate immediately after a backwash to a pre-determined level and for a pre-determined time sufficient to enable re-growth of the microbes substantially to a pre-backwash level; and
i) after boosting the chemical feed rate for the pre-determined time, returning the carbon source control to the system described in steps a-g.

15. The method according to claim 14, wherein the amount by which the carbon feed rate is boosted is a set amount or is determined as a function of temperature and other factors.

16. The method according to claim 14, wherein the time for which the boosted carbon feed rate is applied is a set amount or is calculated based on a microbial doubling time.

17. The method according to claim 14, wherein the filter system comprises more than one filtration bed and the boosted carbon feed rate is applied only to an individual filter bed that has just completed a backwash using an auxiliary carbon feeding system.

18. The method according to claim 17, the individual filter bed to which the boosted carbon feed rate has been applied returns to the current carbon feed rate used by other filter beds after the predetermined time by turning off the auxiliary carbon feeding system.

19. The method according to claim 14, wherein a computer processor having a memory and capable of communicating with, receiving inputs from, sending output to, and controlling the filter system and any in-line measurement tools is utilized.

20. An automatic method for dosing and controlling an external carbon source in a denitrification process for a wastewater filter system having influent and effluent aqueous flows and a filtration bed harboring microbes, the method comprising:
a) providing a chemical comprising carbon to the wastewater at a predetermined feed rate;
b) calculating a starting rate of carbon feed based on influent constituent values, influent flow rate and desired effluent values;
c) setting high and low setpoints for effluent nitrate-nitrogen concentration;
d) measuring actual effluent nitrate-nitrogen concentration;
e) comparing the actual effluent nitrate-nitrogen concentration to the desired setpoint;
f) changing the carbon feed rate when the effluent nitrate-nitrogen concentration falls below the low setpoint or above the high setpoint, wherein the carbon feed rate is changed by a user input value or a calculated amount based on the process efficiencies;
g) providing adequate time, as determined by fluid residence time, instrument response time, biological response time, or a combination thereof, for the carbon rate adjustment to take affect and be measured;
h) boosting the chemical feed rate immediately after a backwash to a pre-determined level and for a pre-determined time sufficient to enable re-growth of the microbes substantially to a pre-backwash level; and
i) after boosting the chemical feed rate for a pre-determined time, returning the carbon feed rate to an average feed rate of one or more previous filter runs after the application of the boosted carbon feed rate has been completed, a filter run being defined as the operational time between backwashes.

21. The method according to claim 20, wherein the filter system comprises more than one filtration bed and the boosted carbon feed rate is applied only to an individual filter bed that has just completed a backwash using an auxiliary carbon feeding system.

22. The method according to claim 21, wherein the individual filter to which the boosted carbon feed rate is applied returns to the average feed rate of one or more previous filters run after the predetermined time, by turning off the auxiliary carbon feeding system.

23. The method according to claim 20, wherein a computer processor having a memory and capable of communicating with, receiving inputs from, sending output to, and controlling the filter system and any in-line measurement tools is utilized.

24. A system for controlling carbon additions to a filter system having influent and effluent aqueous flows and a filtration bed harboring microbes, the system comprising two systems for providing a chemical source of carbon to the influent wherein a first system provides the necessary amount of carbon to reduce effluent nitrate-nitrogen concentration to a desired level and a second system provides a boost of carbon after the filter system has completed a backwash cycle.

25. The system according to claim 24, further comprising a computer processor for controlling the two systems for providing a chemical source of carbon.

26. The system according to claim 24, wherein the filter system comprises more than one filtration bed and the second system is capable of supplying the boost of carbon to only the filtration bed that has just completed a backwash.
